(19) United States
(12) Patent Application Publication
(10) Pub. No.: US 2008/0250115 A1
(43) Pub. Date: Oct. 9, 2008

(54) Enterprise Notification System

(76) Inventor: Vaidy Iyer, Tempe, AZ (US)

Correspondence Address: MUSKIN & CUSICK LLC, 30 Vine Street, SUITE 6, Lansdale, PA, 19446, US

(21) Appl. No.: 11/738,508

(22) Filed: Apr. 22, 2007

Related U.S. Application Data
(60) Provisional application No. 60/913,270, filed on Apr. 21, 2007.
(60) Provisional application No. 60/910,174, filed on Apr. 4, 2007.
(60) Provisional application No. 60/912,101, filed on Apr. 16, 2007.

(51) Int. Cl. G06F 15/16

(52) U.S. Cl. 709/207

(57) ABSTRACT

A system for notifying an end-user of the occurrence of an event is disclosed. The inventive concept comprises a front-end system that is accessible by the end-user, and a back-end system that is remotely accessible through the front-end system. The front-end system contains one or more mini-applications associated with various back-end applications. Each mini-application employs an information gathering procedure which is used to discover the occurrence of a remote event in an associated back-end application. When an event occurs, the mini-application notifies the end-user of its occurrence and, upon the end-user's request, directs the end-user to a separate application accessible to the front-end system, which is used handle the event.

### CROSS REFERENCE TO RELATED APPLICATIONS

This Application claims benefit to provisional application 60/913,270, which is incorporated by reference herein in its entirety. This application also claims benefit to provisional application 60/910,174, which is incorporated by reference herein in its entirety. This application also claims benefit to provisional application 60/912,101, which is also incorporated by reference herein in its entirety.

### FIELD OF THE INVENTION

The present inventive concept relates to the field of computer applications, and more particular, to systems for notifying users of events.

### BACKGROUND

Electronic notification systems already exist in the prior art.

However, what is needed is a system that can improve over the prior art by better preserving computing resources as well as output device resources, as well as by providing a more scalable system.

### SUMMARY OF THE INVENTION

It is an aspect of the present inventive concept to provide a system for notifying a user of a remotely occurring event.

The above aspects can be achieved by (a) a front-end system utilizing an information gathering procedure to send a request to a back-end system; (b) a back-end system using a request-handling procedure to send a response; (c) the front-end system employing a notification procedure to notify the user of the occurrence of an event; and (d) the front-end system invoking an event-handling procedure to enable the user to take appropriate action with respect to the event.

The above aspects can also be achieved by a method that includes (a) gathering input from the end-user of a front-end system; (b) setting connection settings and business rules based on the input acquired from the end-user; (c) sending a web service request from the front-end system to a back-end system; (d) sending a web service response from the back-end system to the front-end system; and (e) displaying a pop-up notification to the end-user using the web service response.

The above aspects can also be achieved by a system that includes (a) a front-end system directly accessible by an end-user, the front-end system running a mini-application; and (b) a back-end system remotely accessible by an end-user through the front-end system, the back-end system associated with the mini-application, (c) wherein the mini-application employs a notification procedure wherein the back-end system can notify the end-user of an event which has occurred, (d) wherein the mini application allows the end-user to respond to the event directly inside the mini-application.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

Further features and advantages of the present inventive concept, as well as the structure and operation of various embodiments of the present inventive concept, will become apparent and more readily appreciated from the following description of the preferred embodiments, taken in conjunction with the accompanying drawings of which:

FIG. 1 is a process flow-chart for an exemplary mini-application running on a front-end system, according to an embodiment;

FIG. 2 is a process flow-chart for an exemplary back-end application running on a back-end system, according to an embodiment;

FIG. 3 is a network diagram illustrating how the various elements of the inventive concept are interconnected over a network, according to an embodiment;

FIG. 4 is a network diagram illustrating the data flow process to and from a front-end system and a back-end system, according to an embodiment;

FIG. 5 is a screen shot illustrating an exemplary automatic notification on a desktop, according to an embodiment; and

FIG. 6 is an illustration of a screen shot with a mini-application displaying an automatic notification with embedded buttons, according to an embodiment.

### DETAILED DESCRIPTION

Reference will now be made in detail to the presently preferred embodiments of the inventive concept, examples of which are illustrated in the accompanying drawings, wherein like reference numerals refer to like elements throughout.

The present general inventive concept relates to a system and method for notifying an end-user of a remotely occurring event. The term “end-user” refers to a user of a front-end system 300. A front-end system 300 may be any computing device. In an exemplary embodiment, the front-end system is a desktop computer. In other embodiments, the front-end system 300 may be a cellular phone, personal digital assistant (PDA), portable music player, or a notebook computer. The front-end system 300 is the system which acquires notice of an event, while the back-end system 308 is the locus of the event. Like the front-end system 300, the back-end system 308 may be any computing device. In an exemplary embodiment, the back-end system 308 is a server capable of handling a high processing load.

The front-end system may run one or more mini-applications to achieve this functionality. The mini-application may be developed on any platform or operating system. In some embodiments, the mini-application is Google gadget running under the Google Desktop framework. In other embodiments, the mini-application is a Yahoo! widget, or a Windows Vista gadget. The mini-applications communicate with a back-end application running on a back-end system. In an exemplary embodiment, the back-end system is an SAP system, and the back-end applications are SAP applications.

The event which the end-user receives notification of could be any conceivable event. In some embodiments, the event is a business event, process, or workflow. The event could be receipt of an order, shipment of an order, notification indicating that the user must approve a document such as an invoice, notification that a machine or a plant has gone down, notifications of delays in shipment, and notifications indicating whether a supplier will be able to meet his or her promised deliveries. However, the event could be any event that the mind can conceive of, and need not be limited to the examples disclosed herein.

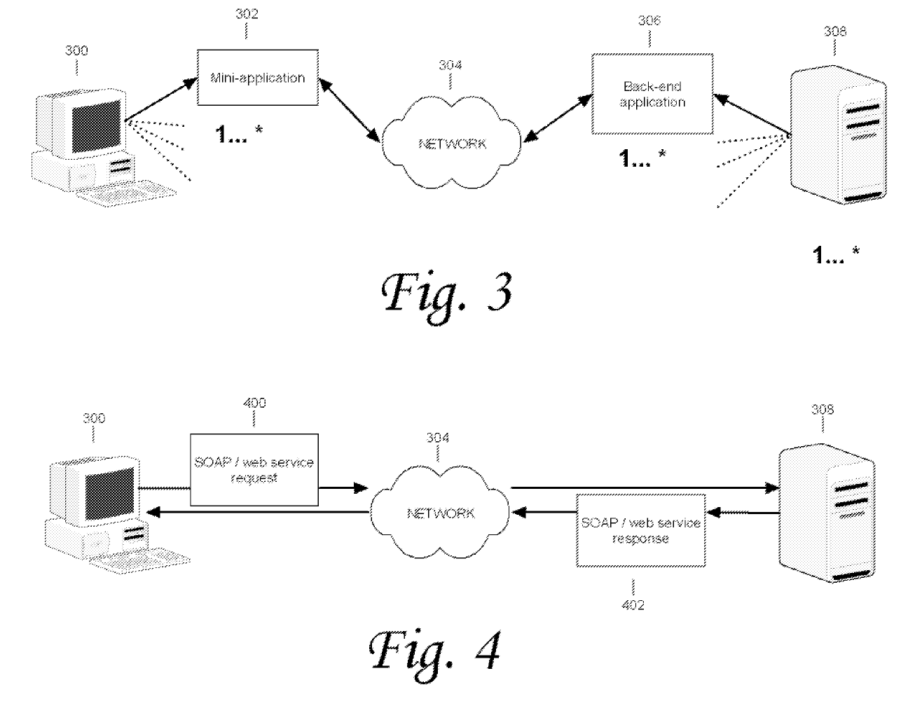

Referring to FIG. 3, a network diagram is set forth illustrating the various elements of an embodiment of the inventive concept and how they are interconnected through a network 304. A front-end system 300 may run one or more mini-applications 302. Each mini-application 302 is associated with one or more back-end applications 306 which run on the back-end system 308. The front-end system 300 may run multiple mini-applications 302 according to the end-user's preferences or business requirements. By limiting the number of mini-applications 302 to those in which end-user has an interest, system resources may be conserved. The front-end system 300 is not limited to running only mini-applications 302; in an exemplary embodiment, the front-end system 300 is a computing device having an operating system and multiple applications running simultaneously. Mini-applications 302 are latent applications that occupy a comparatively small amount of display space and system memory.

Each mini-application 302 is associated with one or more back-end applications 306 which run on the back-end system 308. The front-end system 300 may run multiple mini-applications 302 according to the end-user's preferences or business requirements. For example, when the end-user is an employee of a company, he or she may wish to be informed of some business events and not others. A sales representative may wish to receive notice of receipt of e-mail and product orders. Accordingly, the sales representative may run two mini-applications 302 on his front-end system 300, one associated with a back-end e-mail application, and another associated with a back-end application 306 which records the receipt of product orders. In contrast, a plant manager may wish to receive notice of e-mail and also be informed of the status of plant machinery. Accordingly, the plant manager may run the same e-mail mini-application 302 as the sales representative, as well as a mini-application 302 associated with a back-end application 306 which monitors the status of plant machinery. The plant manager may abstain from running a mini-application 302 which presents notification of product orders because this may be outside the scope of his responsibilities. By limiting the number of mini-applications 302 to those in which end-user has an interest, system resources may be conserved. In some embodiments, a single mini-application 302 may notify the user of a plurality of diverse events. For example, one mini-application 302 may inform a user of both e-mail and product order events.

The mini-applications' 302 associated back-end applications 306 need not be located on the same back-end system 308; several independent back-end systems 308, each running one or more back-end applications 306, may be involved. In some embodiments, data is transmitted between the front-end system 300 and back-end system 308 through a network 304. This network may be, for example, the Internet. However, in other embodiments the network may be a local area network (LAN), a wireless local area network (WLAN), or the front-end system 300 may connect directly to the back-end system 308 via a cross-over cable or a wireless connection.

In an exemplary embodiment, the back-end system 308 in an SAP system, and the back-end applications 306 are SAP applications. SAP is a software company which specializes in the development of business software. In an exemplary embodiment, several mini-applications 302 may be run on a front-end system 300, each associated with a different SAP back-end application 306. These back-end applications 306 may be, for example, the following SAP applications: Customer Relationship Management (CRM), Enterprise Resource Planning (ERP), Supply Chain Management (SCM), Strategic Enterprise Management (SEM), Manufacturing Integration and Intelligence (xMII), Supplier Relationship Management (SRM), Business Intelligence (BI), Exchange Infrastructure (XI), Master Data Management (MDM), Product Lifecycle Management (PLM), Enterprise Portals (EP), electronic mail applications, or any other SAP back-end application 306. A wide variety of events can occur within a single back-end application 306. Multiple separate mini-applications 302 may receive notice of different events from the same back-end application 306, or a single mini-application 302 may receive notice of a variety of events from one or more back-end applications 306.

The mini-applications 302, which run on a front-end system 300, may take several forms. In an exemplary embodiment, the mini-application is a “gadget” which runs under the Google Desktop platform, and is implemented using Google's application programming interface (API). In other embodiments, the mini-application is a Yahoo! widget or running under the Yahoo! engine platform, or a Windows gadget running under Windows Vista or other Windows operating systems. However, the mini-applications could be designed to function with any platform or operating system, including Linux, Solaris, OSX, and others. The inventive concept disclosed therefore need not be limited to any specific platform or operating system. The mini-applications 302 may be integrated to any SAP back-end application by utilizing the SAP API.

The mini-applications 302 are referred to as “mini” because they tend to occupy comparatively little computing resources and in some embodiments they may be run in lieu of a more major application (for example, a mySAP application). The mini-applications 302 gather information which relates to a corresponding major application through their information gathering procedures. Because the functionality of the mini-applications 302 is generally limited to gathering information about remote events and notifying the user of those events, the mini-applications 302 take up less system resources than their corresponding major applications. In some embodiments, the mini-applications 302 allow an end-user to handle aspects of an event directly within the mini-application 302. The mini-application 302 can accomplish this, for example, by acquiring input from the end-user in a pop-up window containing a text field. A variety of other methods for obtaining user input may also be utilized. For example, the mini-application 302 may acquire input through radio buttons, checkboxes, audio through a microphone, or any other means for obtaining user input. After acquiring input, the mini-application will transmit appropriate instructions or information to the back-end application 306. When substantial back-end interaction is required the mini-application 302 can re-direct the user to a corresponding major application such as mySAP. In this way, system resources are conserved. An additional benefit is that while major applications tend to occupy a large amount of screen space, mini-applications 302 are comparatively less obtrusive. In some embodiments, the mini-application will operate invisibly, surfacing only to notify the user of the occurrence of an event. In other embodiments, a small icon representing the mini-application 302 may be displayed in a reserved portion of the display, such as a system tray, normally located at the bottom right of the display on a front-end system.

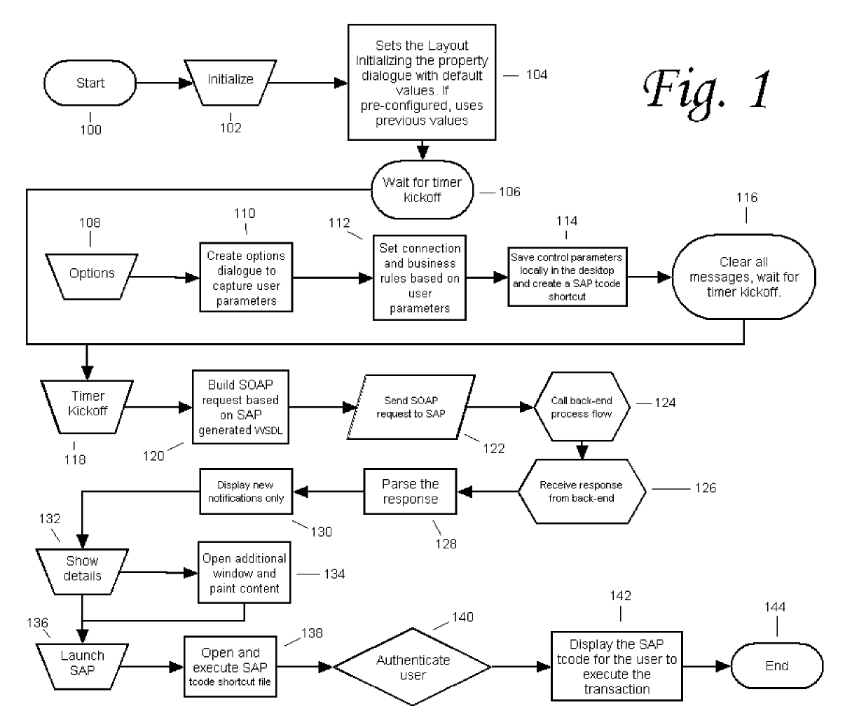

Referring to FIG. 1, an exemplary process flow-chart for a mini-application 302 running on a front-end system 300 is set forth. At operation 100, the mini-application 302 is executed by the front-end system 300. The mini-application 302 may automatically load upon booting the front-end system 300, or it may be executed manually by the end-user, either by double-clicking or entering a command in a command-line interface, as is known in the art. At operation 102, the program is loaded into the front-end system's 300 memory, normally the front-end system's 300 RAM (random access memory). At operation 104, the mini-application 302 reads a configuration file normally stored in the front-end system's 300 secondary memory (for example, a hard disk drive), and parses the file to determine what settings to apply as is known in the art. These settings may include connection settings, which specify the network address of the back-end system 308 as well as authentication information for that system, if required. They may also include business rules which may specify the type of information that the end-user is notified of. In an exemplary embodiment, the settings will also include a timer variable indicating the amount of time to elapse between each execution of the mini-application's information gathering procedure. If no settings are present, the mini-application will skip to operation 108, where the end-user will be presented with an options menu. If the mini-application 302 has already been configured, it will proceed to operation 106 where it will wait for a timer kickoff. A timer kickoff occurs when the amount of time specified in the timer variable elapses.

In operation 108, the end-user may access an options menu where he or she may specify connection settings and business rules. The end-user may also input authentication information such as a screen name and password or biometric data. The authentication information may then be used to authenticate the front-end system 300 with one or more back-end systems 308. The process of configuring the mini-application 302 is illustrated in operations 108, 110, 112, 114, and 116. If the end-user has already configured values at an earlier time, these earlier values will be applied, as shown in operation 104. In operation 110, the end-user is presented with a dialog box to gather input from the end-user. In this dialog box, the end-user may specify business rules and connection settings using any method, such as inputting text into a textbox, clicking a checkbox or radio button, or using a touch screen or microphone to acquire input from the end-user. These settings will then be applied in operation 112; they will be stored in RAM so that they will be applied in subsequent operations of the process. In operation 114, the settings will be written to the configuration file for future use.

An SAP tcode shortcut is involved in operation 114. Within SAP, there are various transaction-code for every business process. These transaction-code are sets of programs & input screens that accept certain inputs, processes and does the respective business process, e.g. there is a transaction code (also known as tcode) for creating a purchase order, a tcode for changing a purchase order and a separate code for displaying a tcode. A user has to normally navigate through a long tree structure to get to a particular transaction-code or he can type in a shortcut code to get to that particular transaction. Here the gadget (or mini-application) creates a tcode shortcut file that is stored in the front-end desktop. On double-clicking the message in the gadget, this tcode shortcut is triggered that takes the user directly to the specific transaction-code in SAP., e.g., if a user gets PO approval alert, he/she will double-click which will take the user directly to the PO approval transaction-code

In operation 116, the gadget keeps a temporary copy of all alerts in the desktop. This is done so that the new messages are compared against the old ones and it only alerts/prompts for the new ones. When the options dialog is saved, these messages from the temporary storage in the desktop are cleared. In operation 116, the options dialog is completed, and the mini-application 302 will wait for a timer kickoff, which occurs when the amount of time specified in the timer variable elapses.

An exemplary mini-application's 302 information gathering procedure is illustrated in operations 118, 120, 122, 124, 126, and 128. In this embodiment, the mini-application 302 gathers information about the occurrence of an event by periodically sending requests to a back-end system 308. A timer is used to determine the frequency of requests. The length of time between requests could be any time, and in some embodiments it will vary based on the nature of the event or the end-user's preferences as specified in the options menu. For example, a mini-application 302 monitoring for plant failure or other mechanical failures may send requests quite frequently while a mini-application 302 which checks for new e-mail may only send a request once per minute.

The amount of time will typically be specified in a timer variable stored in the configuration file and in RAM. When the specified time period elapses a timer kickoff 118 occurs, which begins the information gathering procedure. After the entire process in FIG. 1 is completed (at operation 144), the mini-application returns to operation 106, the timer starts again and the process repeats until the program is terminated. The mini-application may be terminated by end-user action, when the front-end system is turned off, or any other means of termination. In an exemplary embodiment, the mini-application 302 remains dormant while it is waiting for a timer kickoff.

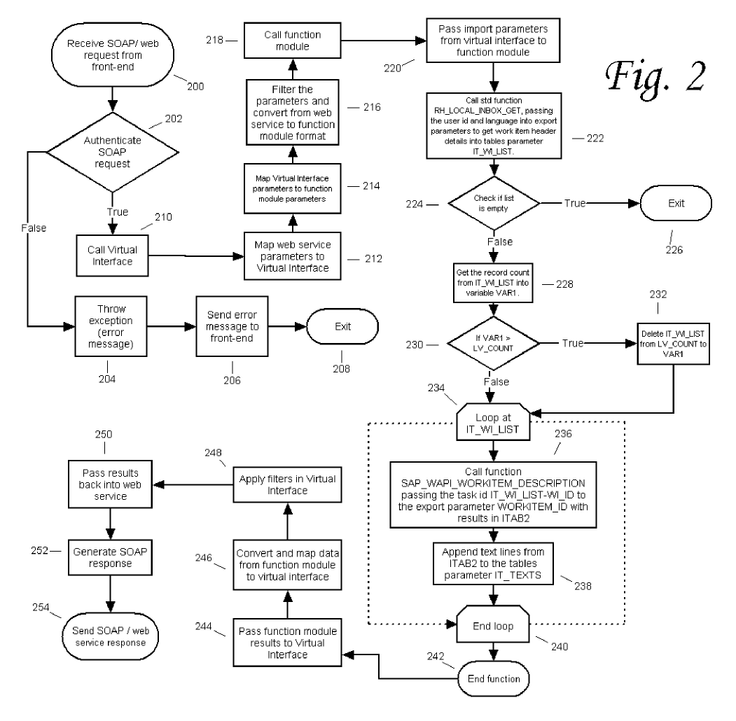

The information gathering procedure commences in operation 118, when a timer kickoff occurs. In an exemplary embodiment, the mini-application's 302 information gathering procedure comprises sending a web service request to a backend system. This web service request is based on SAP's web services description language (WSDL), from which a simple object access protocol (SOAP) request is generated. The WSDL is essentially a directory of services which may be activated by a SOAP request. These services may include acquiring notice of an event. At operation 120, the mini-application generates a SOAP request in string format, using the WSDL as a guideline to formulate an appropriate request for the desired information. The SOAP request may be created dynamically using the WSDL or its format may be pre-configured in the mini-application, being modified to include the end-user's personal information and business rules, which may be specified in the options dialog. The mini-application sends the SOAP request 400 to the back-end system 122, usually over a network 304, at which point the back-end system 308 invokes its request-handling procedure 124 and returns a SOAP response 126, 402 to the front-end system 300. This process is shown in more detail in FIG. 2. The mini-application 302 then parses the response 128, completing the information gathering procedure. SOAP requests and responses are in a typical XML format.

When the mini-application parses the SOAP response, it filters through the tags in the response to separate the information that was requested into separate variables, eliminating the tags. In the e-mail context, for example, the subject and message body may be parsed into two separate string variables and presented to the end-user appropriately. SOAP requests and responses function as the common link between the front-end system 300 and the back-end systems 308, allowing them to be integrated. The information gathering procedure need not take the form of a web service request 400 and response 402—it may take any other form. In alternate embodiments, the mini-application does not periodically transmit requests, but instead receives a stream of data from a back-end system 308.

After the mini-application 302 executes its information gathering procedure, the notification procedure will be invoked. An exemplary notification procedure is shown in operations 130, 132, and 134. If the information gathering procedure produces a new event for which the end-user has not been notified, a notice of that event will temporarily be shown on the display of the front-end system 300 in operation 130. It is possible that the back-end application will not determine whether the end-user has already received notification of an event during operation 124. In this case, the mini-application must determine whether the information in the SOAP response 402 is relevant to the user. The mini-application 302 can accomplish this any number of ways. In some embodiments, the mini-application maintains a data structure, such as an array, containing previous notifications presented to the end-user. The mini-application 302 will then iterate through the data structure to compare all prior notifications to the information in the SOAP response. If the information in the SOAP response is identical to a previous notification, the mini-application will not deliver the notification to the user in operation 130, but will instead go back to operation 106 to wait for a timer kickoff. The notification in operation 130 could take the form of a pop-up window containing a written message. However, the notification could also take the form of an audio message, printing a message from a printer, faxing a message, or any form of output that a computing device is capable of producing. A combination of outputs may also be utilized. For example, a pop-up window may be used in combination with an auditory message.

At operation 132, the end-user will then have the option of clicking on the pop-up message with a mouse, or otherwise interacting with the mini-application 302 to gather more information relating to the event for which the end-user has received notification of. In an exemplary embodiment, the subject line of a message is presented in a pop-up notification in operation 130. If the user clicks on the subject of the message, the body of the message may be presented to the end-user in operation 132. The end-user may then be given the option of indicating whether he wishes to respond or otherwise handle the notification in operation 132. If the end-user interacts with the notification in this way, operation 134 may be invoked and additional information relating to the event will be displayed or otherwise output to the user, giving the user the option to handle the event within the mini-application. This is one kind of event handling procedure utilized by the mini-application 302. In the e-mail context, the end-user may be given the option to compose a message within the mini-application 302 in operation 134. The mini-application 302 may then handle the event by sending data directly over a network to the back-end application 306, or it may proceed to launch a local application, such as mySAP, in operation 136. In some embodiments, operation 134 is skipped and the mini-application 302 will immediately launch a local application when the end-user indicates a desire to handle the event that he or she has been notified of. This alternate event handling procedure is illustrated in operations 136, 138, 140, and 142.

In operation 136, a local application is launched on the front-end system. The mini-application 302 calls a local application on the front-end system 300 which is related to the notification it has presented the end-user. The mini-application 302 may do this automatically or it may do so in response to the end-user's request. In operation 138, the mini-application 302 opens and executes the SAP tcode shortcut file.

An SAP tcode shortcut file is a executable code from SAP that resides in the desktop. This file is created by the Gadget depending on the parameters entered by the user in the Option dialog. This file, being an executable code, is executed when a user double-clicks on the message to take him/her to the respective SAP transaction. At operation 140, the end-user is authenticated with the back-end system. This may be accomplished automatically by the mini-application 302 by using the authentication settings specified in the options dialog. At operation 142, the SAP tcode is displayed for the user to execute the transaction, completing the mini-application's event-handling procedure. An SAP tcode is a transaction code in SAP that is a combination of different programs, User-Interface screens, etc. Normally a SAP transaction code is related to a specific business process, e.g., invoice creation or Purchase order creation.

The user is then free to interact with the local application and handle the underlying event as he so chooses. In the e-mail context, for example, the user may choose either to reply, forward, delete, or other action upon the e-mail for which he received notification of. At operation 144 the mini-application 302 may either terminate itself, or it may go back to operation 106.

The source code in Appendix B corresponds to the embodiment of the mini-application 302 shown in FIG. 1 and discussed in the preceding paragraphs:

Referring to FIG. 2, a flow-chart depicting a request-handling procedure for a back-end system 308 is set forth according to an embodiment. In an exemplary embodiment, this process begins at operation 124 in FIG. 1 after the front-end system 300 transmits a request to the back-end system 308. Initially, in operation 200 a SOAP request is received from the front-end system 300. In operation 202, the soap request is authenticated. In order for this to be accomplished, the SOAP request must be parsed for authentication data. The authentication data could be, in some embodiments, a username and a password. The data will be authenticated against a back-end user database, as is known in the art. If authentication fails operation 204 is invoked, and an exception is thrown. At operation 206, an error message is transmitted back to the front-end system 300. The mini-application 302 will then notify the end-user of the error.

If the SOAP request is successfully authenticated, the process moves to operation 210, where a virtual interface is called. A virtual Interface is a SAP specific name. A virtual interface can act as a bridge between the SAP function module (which is a program) and a web service. The purpose is to tune the parameters of the function-module to that of a web-service, e.g., an input parameter may be called as “Business Partner” in a function module but will be called as Supplier in the web-service, Although both of them may mean the same thing and refer to the same field.

The back-end system cannot utilize the data in the SOAP XML-based format, so in operations 212, 214, and 216 the data in the SOAP request will be converted to a format that the back-end application can use. In operation 212, the parameters in the SOAP request are mapped to corresponding parameters in a virtual interface. This is accomplished by parsing the request to acquire the underlying data, and storing (mapping) the data in parameters (data structures) within the virtual interface. In operation 214, the data is once again converted. This time, the data in the virtual interface parameters are mapped to the function module's parameters. The function module is what actually acquires the data requested by the mini-application 302. In operation 216, the parameters are filtered and converted from web service to function module format. The conversion/filteration can be performed done by the virtual interface

In operation 218, the function module is called. In operation 220, the parameters are passed from the virtual interface to the function module, having been converted to a format that the function module can utilize. In this embodiment, the back-end application is an e-mail application. The messages are referred to as “work items”. In operations 222 through 240, the process of checking for new messages is shown. In operation 222, the function RH_LOCAL_INBOX_GET is called which obtains the headers of all unread messages in the end-user's inbox. These message headers are then stored in a data structure IT_WI_LIST. At operation 224, if the list is empty, the process moves to operation 226. At operation 226, the list is empty so the user has no new messages.

The process will then proceed to operation 244. If the list is not empty, the process moves to operation 228. At operation 228, the number of headers in the data structure is determined and stored in a variable known as VAR1. The determination is actually done in operations 230 and 232. If operation 230 (VAR1>LV_COUNT) evaluates to true, operation 232 will be invoked. In operation 232, the number of headers in IT_WI_LIST will be copied to VAR1. This variable will then be used to execute a loop in operation 234. In operation 236, the function SAP_WAPI_WORKITEM_DESCRIPTION is called, passing the task id into its export parameter and putting the results in the ITAB2 data structure. Operation 236 essentially gathers message body (task description) for each header and places it in a string variable ITAB2. In operation 238, the contents of ITAB2 are appended to the tables parameter IT_TEXTS. When the loop is completed at operation 240, IT_TEXTS will contain all the new messages (task descriptions) for the end-user.

```
[CODE]
FUNCTION ZEDN_LOCAL_INBOX_GET.
*“----------------------------------------------------------------------
*“*”Local Interface:
*“ IMPORTING
*“  VALUE(LV_UNAME) LIKE SY-UNAME
*“  VALUE(LV_LANGU) LIKE SY-LANGU DEFAULT SY-LANGU
*“  VALUE(LV_COUNT) TYPE INT4 DEFAULT 10
*“ TABLES
*“  IT_WI_LIST STRUCTURE SWWWLHEAD OPTIONAL
*“  IT_TEXTS STRUCTURE HRS1002 OPTIONAL
*“-----------------------------------------------------------------------
  DATA : LV_LINES TYPE  I,
        WA_WI_LIST TYPE SWWWLHEAD,
        WA_TEXTS TYPE  HRS1002,
        WA_TLINE TYPE  TLINE,
        IT_TLINE TYPE TABLE OF TLINE.
* Get the workflow items for the user.
  CALL FUNCTION ‘RH_LOCAL_INBOX_GET’
    EXPORTING
      USER_ID  = LV_UNAME
      USER_LANGU = LV_LANGU
    TABLES
      WI_LIST  = IT_WI_LIST.
* EXCEPTIONS
*  USER_CANNOT_GET_WI  = 1
*  OTHERS  = 2
  IF SY-SUBRC EQ 0.
    SORT IT_WI_LIST BY WI_CD DESCENDING.
* Get the number of work items.
    DESCRIBE TABLE IT_WI_LIST LINES LV_LINES.
    IF LV_LINES GT LV_COUNT.
      ADD 1 TO LV_COUNT.
      DELETE IT_WI_LIST FROM LV_COUNT TO LV_LINES.
    ENDIF.
* Get the task description for all the Work Items one by one.
    LOOP AT IT_WI_LIST INTO WA_WI_LIST.
* Read the task description.
      READ TABLE IT_TEXTS INTO WA_TEXTS
      WITH KEY OTYPE = WA_WI_LIST-WI_RH_TASK(2)
            OBJID = WA_WI_LIST-WI_RH_TASK+2(12).
* If the Task description has been already inserted do not call the fm.
      IF SY-SUBRC NE 0.
* Call the function to get the Task description.
      CALL FUNCTION ‘RH_TEXT_READ’
        EXPORTING
          ACT_OBJECT_EXT =
          WA_WI_LIST-WI_RH_TASK
* ACT_SUBTY  =
          ACT_BEGDA  = SY-DATUM
          ACT_ENDDA  = SY-DATUM
          ACT_LANGU  = LV_LANGU
        TABLES
            ACT_TEXT  = IT_TLINE.
* EXCEPTIONS
* NO_ACTIVE_PLVAR  = 1
* NO_TEXT_FOUND  = 2
* OTHERS  = 3
        IF SY-SUBRC EQ 0.
          LOOP AT IT_TLINE INTO WA_TLINE.
            MOVE : WA_WI_LIST-WI_RH_TASK(2)
            TO WA_TEXTS-OTYPE,
                WA_LIST-WI_RH_TASK+2(8)
                TO WA_TEXTS-OBJID,
                WA_TLINE-TDFORMAT
                TO WA_TEXTS-TFORMAT,
                WA_TLINE-TDLINE  TO WA_TEXTS-TLINE.
            APPEND WA_TEXTS TO IT_TEXTS.
            CLEAR WA_TEXTS.
          ENDLOOP.
        ENDIF.
      ENDIF.
    ENDLOOP.
  ENDIF.
ENDFUNCTION.
[/CODE]
```

After the function module has completed this process, the resulting data is passed to the virtual interface 244. The data is then converted and mapped to the virtual interface 246, filters are applied 248, and then results are passed back to a web service 250. A SOAP response is then generated 252 and sent to the front-end system 300. The front-end system 300 receives the response 126 and subsequently invokes its notification procedure. It is important to note that the request-handling procedure depicted in FIG. 2 is only one embodiment. In other embodiments, this procedure will be different, particularly the function module process, which will vary greatly even between each SAP back-end application 306.

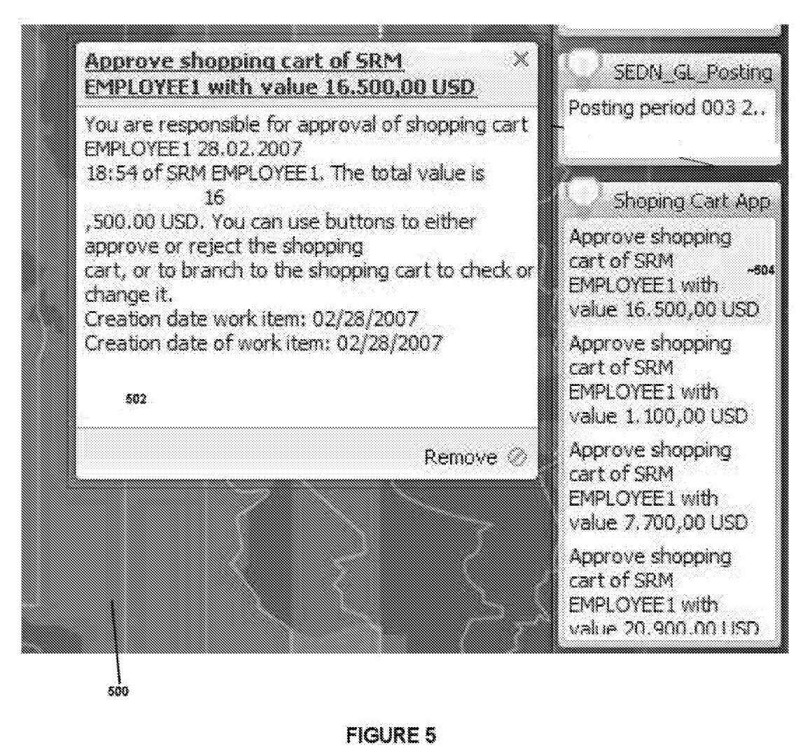

FIG. 5 is a screen shot illustrating an exemplary automatic notification on a desktop, according to an embodiment.

A desktop 500 is illustrated in the background workspace of a computer display. “Wallpaper” can typically be displayed on portions of the desktop not utilized by the user. An enterprise notification pop up 502 can appear on the user's desktop with a message, for example one relating to an ERP system. An acceptance button 506 can be used (clicked) by the user to accept the request. If the user accepts, then the acceptance can be transmitted to the back-end system, which can note the acceptance and take appropriate further action. For example, in this case, if the user approves the request in the notification pop up 502, then the back end system can then arrange for completion of the transaction (e.g., completion of the purchase so it can be charged and delivered). The user can also select a button (not pictured) to decline the request in the enterprise notification pop up 502, if the user so chooses.

It is noted that there is not necessarily a one to one correspondence between a number of back-end systems and users. For example, there could be 100 users and one back-end system. Or alternatively, there could be two back-end systems and five users. One back-end system could be an ERP system while another could be a supplier management system. Different notifications from different back-end systems could go to the same mini-application (or alternatively different mini-application)

In an embodiment, the backend system/application can be updated without the end-user having to explicity log-on to the back-end application. If an automatic notification asks the user of the mini-application for approval of a purchase requisition, the end-user can be notified by the mini application (can also be called a gadget). The end-user can then double click on the notification message and he or she will be taken directly to the SAP transaction. The end-user can then be prompted for their user-ID and password login for SAP, wherein the user can log-in and will be automatically taken to the place in SAP where he or she can approve the purchase requisition. In an embodiment, along with the message/alert in the front-end, a yes/no button can be displayed alongside the message in the front-end. The end-user can then press the appropriate yes or no button (send an input) in the front-end on the end-user's desktop, which will update the SAP directly instead of requiring the user to log into SAP to approve or disapprove. The mini-application (or other application local to the end-user) can store the end-users username/passwords which can log on to the SAP application automatically without the user having to manually type these in. Alternatively, the SAP application running on the back-end can be programmed not to require login by a user of the mini-app when an input is received from the end-user. The user of the mini-application can thus make an approval (or other decision) inside the mini-application upon a request without the user having to see the SAP application (screen) at all. Thus, removing the need by the user to manually log in (by typing in his username, password, etc.) makes the system more user friendly.

The embodiments described herein can be applied to any SAP applications, which can include product lifecycle management, enterprise portals, electronic mail applications, and any other SAP applications.

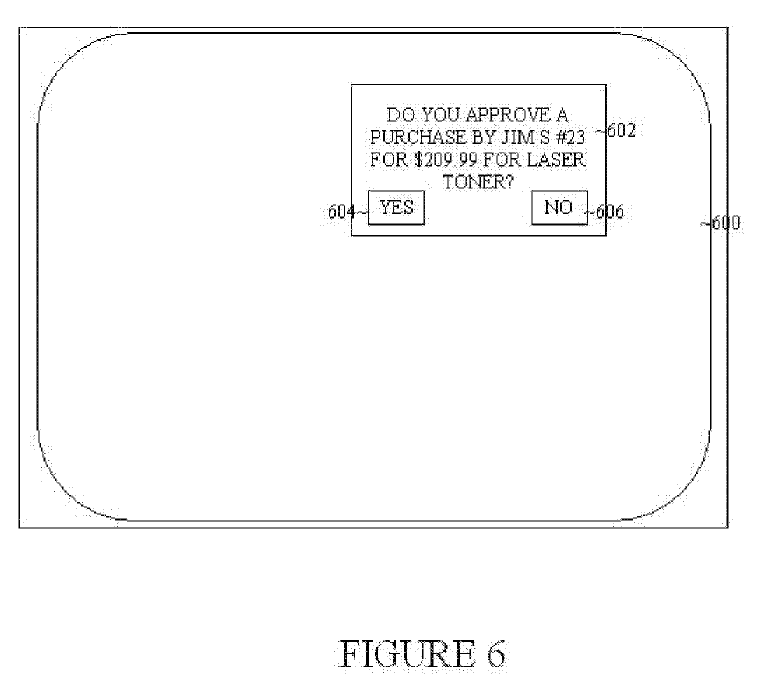

FIG. 6 is an illustration of a screen shot with a mini-application displaying an automatic notification with embedded buttons, according to an embodiment.

A front-end desktop 600 can be used to run variety of applications, such as a word processing application (not pictured) and any others. An automatic notification window 602 can pop up (initiated by the back-end system/application which notifications the front-end) displaying a message to an end-user using the front end. Inside the notification window (or mini-app or gadget) can be buttons (although they can also appear outside of the notification window) that allow the user to respond to the notification with an instruction (e.g., approval of a purchase order, or any other business process/workflow request). A yes button 604 and a no button 606 can be pressed (or clicked) by the user in order for the user to convey his approval or disapproval of the request. The response by the user is then transmitted back to the back-end system which continues with its workflow processing using the response entered by the user. Once the user has responded, the notification window 602 can then disappear.

The present inventive concept may be embodied in the form of computer-implemented processes and apparatus for practicing those processes. The present inventive concept may also be embodied in the form of computer program code embodied in tangible media, such as digital versatile disk (DVD) read only memories (ROMs), CD-ROMs, hard disk drives, flash memories, floppy diskettes, or any other computer-readable storage medium, wherein, when the computer program code is loaded into and executed by a computer, the computer becomes an apparatus for practicing the inventive concept. The present inventive concept may also be embodied in the form of computer program code, for example, whether stored in a storage medium, loaded into and/or executed by a computer, or transmitted over some transmission medium, such as over the electrical wiring or cabling, through fiber optics, or via electromagnetic radiation, wherein, when the computer program code is loaded into and executed by a computer, the computer becomes an apparatus for practicing the inventive concept. When implemented on a general-purpose processor, the computer program code segments configure the processor to create specific logic circuits.

Appendix A lists the front end source code. Appendix B lists the back end source code. In SAP, the back end source code or program created is called as a Function Module. A Function Module is a piece of code that can be called by other programs within SAP or externally by other systems. For EDN, the above Function module can be converted and exposed as a Web Service. Of course the codes illustrates are merely one example of how functionality described herein can be implemented, of course other code structures (and even different computing languages) can be used as well.

Although the inventive concept has been described in terms of exemplary embodiments, it is not limited thereto. Rather, the appended claims should be construed broadly, to include other variants and embodiments of the inventive concept, which may be made by those skilled in the art without departing from the scope and range of equivalents of the inventive concept.

What is claimed is:

1. A computer implemented method of notifying the end-user of a front-end system of a remote event, the method comprising:
acquiring input from the end-user;
sending a request from a front-end system to a back-end system;
sending a response from the back-end system to the front-end system;
displaying a pop-up notification on the front-end system; and
handling the pop-up notification by calling another process on the front-end system from which the end-user may access the back-end system application.

2. The method as recited in claim 1 further comprising:
storing back-end authentication information on the front-end system; and
authenticating the front-end system with the back-end system.

3. The method as recited in claim 2 further comprising:
parsing the response; and
determining whether any data in the response is new.

4. The method as recited in claim 3 further comprising:
converting, by the back-end system, the received data from its original format to a format in which a function on the backend system may be executed; and
converting the resultant data to a format which may be utilized by the front-end system.

5. A method of notifying an end-user of a front-end system of an event occurring on a back-end system, the method comprising:
gathering input from the end-user of a front-end system;
setting connection settings and business rules based on the input acquired from the end-user;
sending a web service request from the front-end system to a back-end system;
sending a web service response from the back-end system to the front-end system; and
displaying a pop-up notification to the end-user using the web service response.

6. The method as recited in claim 5, wherein the back-end system is an SAP application.

7. The method as recited in claim 5 further comprising:
mapping the web service request to virtual interface parameters;
converting the virtual interface parameters to a function module format; and
calling the function module.

8. The method as recited in claim 5 further comprising:
acquiring input from the end-user in the pop-up notification; and
transmitting the input to the SAP application.

9. The method of claim 8, wherein the transmitting is performed without the end-user manually logging into the SAP application.

10. A system for notifying an end-user of a business event, the system comprising:
a front-end system directly accessible by an end-user, the front-end system running a mini-application; and
a back-end system remotely accessible by an end-user through the front-end system, the back-end system associated with the mini-application,
wherein the mini-application employs a notification procedure wherein the back-end system can notify the end-user of an event which has occurred,
wherein the mini application allows the end-user to respond to the event directly inside the mini-application.

11. The system as recited in claim 10, wherein the back-end system runs an SAP application.

12. The system as recited in claim 11 wherein the back-end system runs an SAP application comprising one of: Customer Relationship Management, Enterprise Resource Planning, Supply Chain Management, Strategic Enterprise Management, Manufacturing Integration and Intelligence, Supplier Relationship Management, Business Intelligence, Exchange Infrastructure, Master Data Management, Product Lifecycle Management, Enterprise Portals, and electronic mail applications.

13. The system as recited in claim 10, wherein the mini-application implements a gathering operation to gather information from the back-end system, the gathering operation comprising sending a SOAP request from the front-end system to the back-end system and receiving a SOAP response from the back-end system,
wherein a request-handling procedure comprises parsing the SOAP request, associating the SOAP request's parameters with virtual interface parameters, converting the parameters from web service to a function module format, calling a function module, gathering the information requested, and creating a SOAP response.

14. The system as recited in claim 10, wherein the notification procedure comprises displaying a pop-up message on the front-end system's display.

15. The system as recited in claim 14, wherein an event-handling procedure performed on the mini-application comprises running a separate local process corresponding to the mini-application's associated back-end application on the front-end system when the user clicks on or otherwise interacts with a the pop-up message.

16. The system as recited in claim 15, wherein the separate local process is an SAP application.

17. The system as recited in claim 14 wherein the notification procedure comprises an event-handling procedure which acquires input from the user and uses it to update the back-end application.

18. The system as recited in claim 10 wherein the mini-application comprises a Google gadget running under the Google desktop.

19. The system as recited in claim 10 wherein the mini-application comprises a Yahoo! widget.

20. The system as recited in claim 10 wherein the mini-application comprises a Microsoft Vista gadget.

21. The system as recited in claim 10 wherein the mini-application further comprises an options menu wherein the end-user may specify connection settings and business rules.

22. The system as recited in claim 10 wherein the mini-application further comprises an authentication procedure for validating a user's identity.

23. The system as recited in claim 10 wherein,
the mini-application comprises a Google gadget running under the Google desktop;
the back-end system runs at least one SAP applications;
the mini-application performs an information gathering procedure that comprises sending a web service request from a front-end system to a back-end system and receiving a web service response from the back-end system;
the mini-application performs a request-handling procedure that comprises parsing the web service request, associating the web service request's parameters with virtual interface parameters, converting the parameters from web service to a function module format, calling a function module, gathering the information requested, and creating a web service response;
the notification procedure comprises displaying a pop-up message on the front-end system's display;
the mini-applications performs an event-handling procedure that comprises running a separate local process corresponding to the mini-application's associated back-end application on the front-end system when the end-user clicks on or otherwise interacts with a the pop-up message.
